(19) United States
(12) Patent Application Publication
(10) Pub. No.: US 2002/0146022 A1
(43) Pub. Date: Oct. 10, 2002

(54) Credit-based flow control technique in a modular multiprocessor system

(76) Inventors: Stephen R. Van Doren, Northborough, MA (US); Simon C. Steely JR., Hudson, NH (US); Madhumitra Sharma, Shrewsbury, MA (US); Gregory E. Tierney, Chelmsford, MA (US)

Correspondence Address: CESARI AND MCKENNA, LLP, 88 BLACK FALCON AVENUE, BOSTON, MA, 02210, US

(21) Appl. No.: 09/829,038

(22) Filed: Apr. 9, 2001

Related U.S. Application Data
(60) Provisional application No. 60/208,231, filed on May 31, 2000.

(51) Int. Cl. H04L 12/54

(52) U.S. Cl. 370/412; 370/429

(57) ABSTRACT

A credit-based, flow control technique utilizes a plurality of counters to conserve resources of a switch fabric within a modular multiprocessor system while ensuring that transaction packets pending in virtual channel queues of the fabric efficiently progress through those resources. The multiprocessor system includes a plurality of nodes interconnected by the switch fabric that extends from a global input port of a node through a hierarchical switch to a global output port of the same or another node. The resources include shared buffers within the global ports and hierarchical switch. Each counter is associated with a virtual channel queue and the flow control technique uses the counters to essentially create the structure of the shared buffers.

### CROSS-REFERENCE TO RELATED APPLICATIONS

The present application claims priority from U.S. Provisional Patent Application Serial No. 60/208,231, which was filed on May 31, 2000, by Stephen Van Doren, Simon Steely, Jr., Madhumitra Sharma and Gregory Tierney for a CREDIT-BASED FLOW CONTROL TECHNIQUE IN A MODULAR MULTIPROCESSOR SYSTEM and is hereby incorporated by reference.

### BACKGROUND OF THE INVENTION

1. Field of the Invention

The present invention relates to computer systems and, more specifically, to a flow control technique in a multi-channel distributed shared memory multiprocessor system.

2. Background Information

In a modular multiprocessor system, many resources may be shared among the entities or 37 agents” of the system. These resources are typically configured to support a maximum bandwidth load that may be provided by the agents, such as processors, memory controllers or input/output (I/O) interface devices. In some cases, however, it is not practical to configure a resource to support peak bandwidth loads that infrequently arise in the presence of unusual traffic conditions. Resources that cannot support maximum system bandwidth under all conditions require complimentary flow control mechanisms that disallow the unusual traffic patterns resulting in peak bandwidth.

The agents of the modular multiprocessor system may be distributed over physically remote subsystems or nodes that are interconnected by a switch fabric. These modular systems may further be configured according to a distributed shared memory or symmetric multiprocessor (SMP) paradigm. Operation of the SMP system involves passing of messages or packets as transactions between the agents of the nodes over interconnect resources of the switch fabric. To support various transactions in system, the packets are grouped into various types of transactions and mapped into a plurality of virtual channels that enable the transaction packets to traverse the system via similar interconnect resources. The virtual channels may be manifested as a plurality of queues located within, inter alia, the switch fabric of the SMP system.

Specifically, virtual channels are independently flow-controlled channels of transaction packets that share common interconnect resources of the switch fabric which may include a hierarchical switch. The hierarchical switch is a significant resource of the SMP system that is used to forward transaction packets between the nodes of the system. The hierarchical switch is also a shared resource that has finite logic circuits (“gates”) available to perform the packet forwarding function for the SMP system. The present invention is directed, in part, to conserving resources within the switch fabric and, in particular, to reducing the gate count of the application specific integrated circuits of the hierarchical switch.

The transaction packets passed between agents of the system are grouped by type and mapped to the virtual channels to, inter alia, avoid system deadlock. That is, virtual channels are employed to avoid deadlock situations over a common set of interconnect resources, such as links and buffers, coupling the agents of the system. For example, rather than using separate links for each type of transaction packet forwarded through the system, the virtual channels are used to segregate that traffic over a common set of physical links. The present invention is further directed, in part, to managing traffic over the interconnect resources of a SMP system. More specifically, the present invention is directed to increasing the performance and bandwidth of the links and buffers of a switch fabric.

### SUMMARY OF THE INVENTION

The present invention comprises a credit-based, flow control technique that utilizes a plurality of counters to conserve resources of a switch fabric within a modular multiprocessor system while ensuring that transaction packets pending in virtual channel queues of the fabric efficiently progress through those resources. The multiprocessor system includes a plurality of nodes interconnected by the switch fabric that extends from a global input port of a node through a hierarchical switch to a global output port of the same or another node. The resources include, inter alia, shared buffers within the global ports and hierarchical switch. Each counter is associated with a virtual channel queue and the novel flow control technique uses the counters to essentially create the structure of the shared buffers.

In an illustrative embodiment, the multiprocessor system maps the transaction packets into a plurality of virtual channel queues. A QIO channel queue accommodates processor command packet requests for programmed input/output (I/O) read and write transactions to I/O address space. A Q0 channel queue carries processor command packet requests for memory space read transactions, while a Q0Vic channel queue carries processor command packet requests for memory space write transactions. A Q1 channel queue accommodates command response and probe packets directed to ordered responses for QIO, Q0 and Q0Vic requests and, lastly, a Q2 channel queue carries command response packets directed to unordered responses for QIO, Q0 and Q0Vic request.

Each shared buffer comprises a plurality of regions, including a generic buffer region, a deadlock avoidance region and a forward progress region. The generic buffer region includes a plurality of entries for accommodating packets from any virtual channel. A deadlock avoidance region includes an entry for each of the Q2, Q1 and Q0/Q0Vic virtual channel packets. These deadlock avoidance entries allow the Q2, Q1 and Q0/Q0Vic virtual channel packets to efficiently progress through the hierarchical switch independent of the number of QIO, Q0/Q0Vic and Q1 packets that are temporarily stored in the generic buffer region. The forward progress region guarantees timely resolution of all QIO transactions by allowing QIO packets to progress through the system.

According to the inventive technique, each time a controller in the global output port (GPOUT) issues a packet from a virtual channel queue to the hierarchical switch, it increments the counter associated with the queue. Each time the GPOUT controller issues a Q2, Q1, or Q0/Q0Vic packet to the switch and a previous value of the respective counter is equal to zero, the packet is assigned to a respective entry of the deadlock avoidance region in the shared buffer. Each time the GPOUT controller issues a QIO packet to the hierarchical switch and a previous value of the respective counter is equal to zero, the packet is assigned to the entry of the forward progress region.

On the other hand, each time the GPOUT controller issues a Q2, Q1, Q0/Q0Vic or QIO packet to the hierarchical switch and a previous value of the respective counter is non-zero, the packet is assigned to an entry of the generic buffer region. As such, a generic counter is incremented in addition to the counter associated with the virtual channel packet. When the generic counter reaches a predetermined value, all entries of the generic buffer region for that GPOUT controller are full and an input port of the hierarchical switch is defined to be in a RedZone State. When in this state, the GPOUT controller may issue requests to only unused entries of the deadlock avoidance and forward progress regions.

### BRIEF DESCRIPTION OF THE DRAWINGS

The above and further advantages of the invention may be better understood by referring to the following description in conjunction with the accompanying drawings, in which like reference numbers indicated identical or functionally similar elements:

FIG. 1 is a schematic block diagram of a modular, symmetric multiprocessing (SMP) system having a plurality of Quad Building Block (QBB) nodes interconnected by a hierarchical switch (HS);

FIG. 2 is a schematic block diagram of a QBB node coupled to the SMP system of FIG. 1;

FIG. 3 is a functional block diagram of circuits contained within a local switch of the QBB node of FIG. 2;

FIG. 4 is a schematic block diagram of the HS of FIG. 1;

FIG. 5 is a schematic block diagram of a switch fabric of the SMP system;

FIG. 6 is a schematic block diagram depicting a virtual channel queue arrangement of the SMP system;

FIG. 7 is a schematized block diagram of logic circuitry located within the local switch and HS of the switch fabric that may be advantageously used with the present invention; and

FIG. 8 is a schematic block diagram of a shared buffer within the switch fabric that may be advantageously used with the present invention.

### DETAILED DESCRIPTION OF AN ILLUSTRATIVE EMBODIMENT

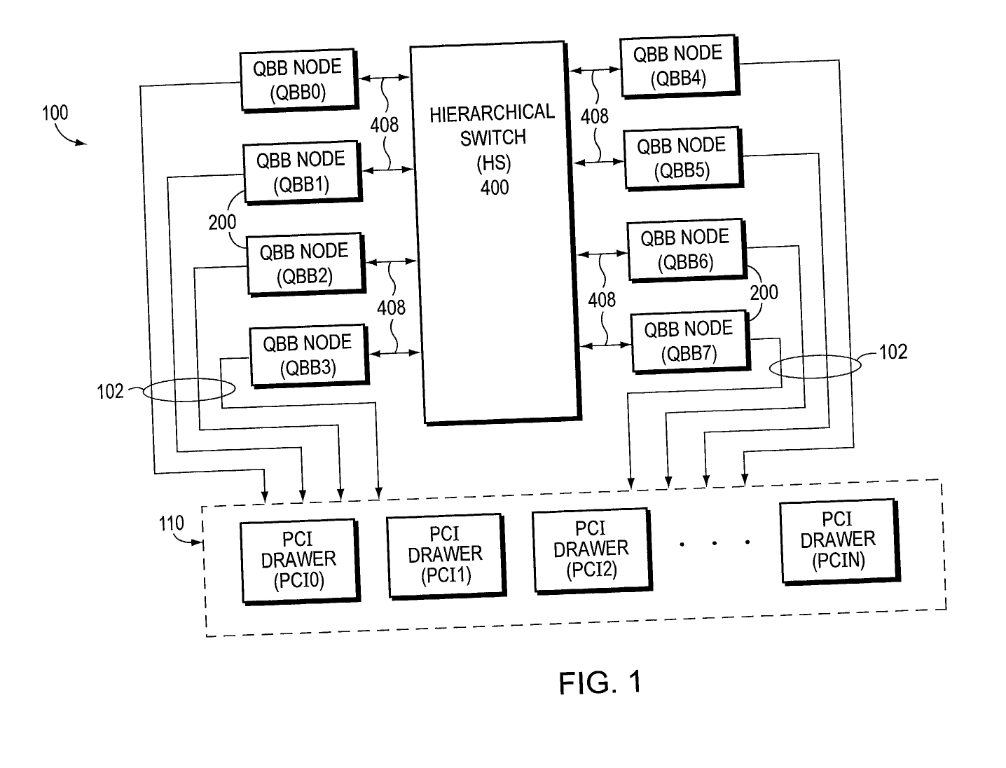

FIG. 1 is a schematic block diagram of a modular, symmetric multiprocessing (SMP) system 100 having a plurality of nodes 200 interconnected by a hierarchical switch (HS 400). The SMP system further includes an input/output (I/O) subsystem 110 comprising a plurality of I/O enclosures or “drawers” configured to accommodate a plurality of I/O buses that preferably operate according to the conventional Peripheral Computer Interconnect (PCI) protocol. The PCI drawers are connected to the nodes through a plurality of I/O interconnects or “hoses” 102.

In the illustrative embodiment described herein, each node is implemented as a Quad Building Block (QBB) node 200 comprising, inter alia, a plurality of processors, a plurality of memory modules, an I/O port (IOP), a plurality of I/O risers and a global port (GP) interconnected by a local switch. Each memory module may be shared among the processors of a node and, further, among the processors of other QBB nodes configured on the SMP system to create a distributed shared memory environment. A fully configured SMP system preferably comprises eight (8) QBB (QBB0-7) nodes, each of which is coupled to the HS 400 by a full-duplex, bidirectional, clock forwarded HS link 408.

Data is transferred between the QBB nodes 200 of the system in the form of packets. In order to provide the distributed shared memory environment, each QBB node is configured with an address space and a directory for that address space. The address space is generally divided into memory address space and I/O address space. As described herein, the processors and IOP of each QBB node utilize private caches to store data for memory-space addresses; I/O space data is generally not “cached” in the private caches.

### QBB Node Architecture

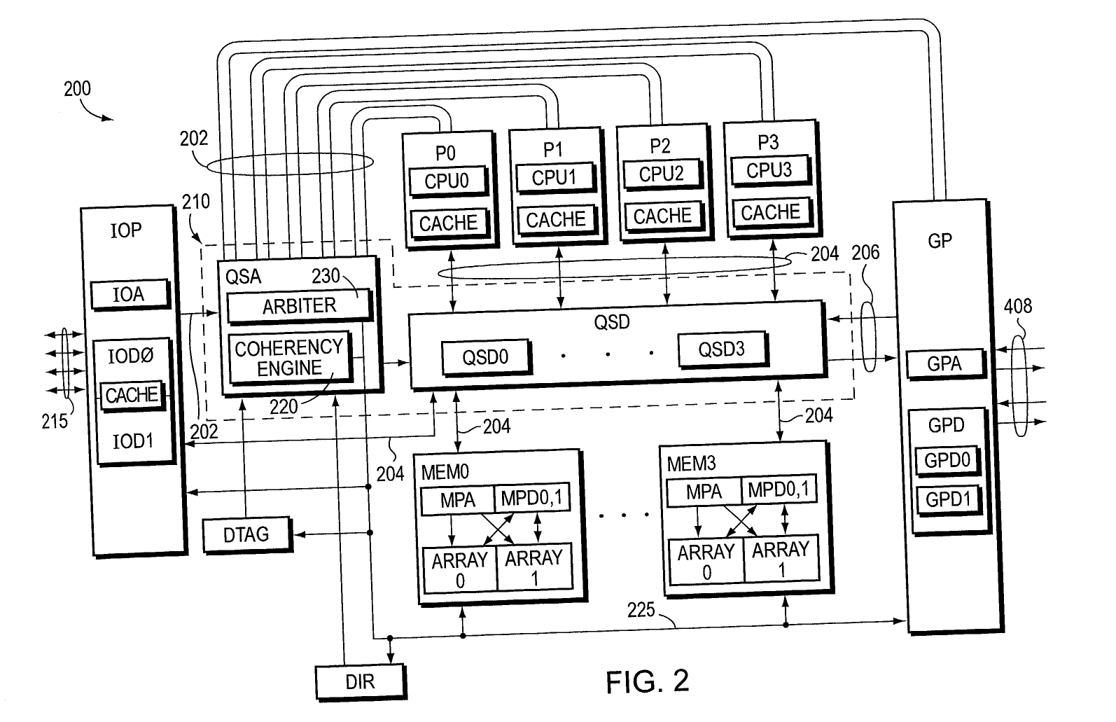

FIG. 2 is a schematic block diagram of a QBB node 200 comprising a plurality of processors (P0-P3) coupled to the IOP, the GP and a plurality of memory modules (MEM0-3) by a local switch 210. The memory may be organized as a single address space that is shared by the processors and apportioned into a number of blocks, each of which may include, e.g., 64 bytes of data. The IOP controls the transfer of data between external devices connected to the PCI drawers and the QBB node via the I/O hoses 102. As with the case of the SMP system, data is transferred among the components or “agents” of the QBB node in the form of packets. As used herein, the term “system” refers to all components of the QBB node excluding the processors and IOP.

Each processor is a modem processor comprising a central processing unit (CPU) that preferably incorporates a traditional reduced instruction set computer (RISC) load/store architecture. In the illustrative embodiment described herein, the CPUs are Alpha® 21264 processor chips manufactured by Compaq Computer Corporation of Houston, Tex., although other types of processor chips may be advantageously used. The load/store instructions executed by the processors are issued to the system as memory reference transactions, e.g., read and write operations. Each transaction may comprise a series of commands (or command packets) that are exchanged between the processors and the system.

In addition, each processor and IOP employs a private cache for storing data determined likely to be accessed in the future. The caches are preferably organized as write-back caches apportioned into, e.g., 64-byte cache lines accessible by the processors; it should be noted, however, that other cache organizations, such as write-through caches, may be used in connection with the principles of the invention. It should be further noted that memory reference transactions issued by the processors are preferably directed to a 64-byte cache line granularity. Since the IOP and processors may update data in their private caches without updating shared memory, a cache coherence protocol is utilized to maintain data consistency among the caches.

The commands described herein are defined by the Alpha® memory system interface and may be classified into three types: requests, probes, and responses. Requests are commands that are issued by a processor when, as a result of executing a load or store instruction, it must obtain a copy of data. Requests are also used to gain exclusive ownership to a data item (cache line) from the system. Requests include Read (Rd) commands, Read/Modify (RdMod) commands, Change-to-Dirty (CTD) commands, Victim commands, and Evict commands, the latter of which specify removal of a cache line from a respective cache.

Probes are commands issued by the system to one or more processors requesting data and/or cache tag status updates. Probes include Forwarded Read (Frd) commands, Forwarded Read Modify (FRdMod) commands and Invalidate (Inval) commands. When a processor P issues a request to the system, the system may issue one or more probes (via probe packets) to other processors. For example if P requests a copy of a cache line (a Rd request), the system sends a Frd probe to the owner processor (if any). If P requests exclusive ownership of a cache line (a CTD request), the system sends Inval probes to one or more processors having copies of the cache line. If P requests both a copy of the cache line as well as exclusive ownership of the cache line (a RdMod request) the system sends a FRdMod probe to a processor currently storing a dirty copy of a cache line of data. In response to the FRdMod probe, the dirty copy of the cache line is returned to the system. A FRdMod probe is also issued by the system to a processor storing a dirty copy of a cache line. In response to the FRdMod probe, the dirty cache line is returned to the system and the dirty copy stored in the cache is invalidated. An Inval probe may be issued by the system to a processor storing a copy of the cache line in its cache when the cache line is to be updated by another processor.

Responses are commands from the system to processors and/or the IOP that carry the data requested by the processor or an acknowledgment corresponding to a request. For Rd and RdMod requests, the responses are Fill and FillMod responses, respectively, each of which carries the requested data. For a CTD request, the response is a CTD-Success (Ack) or CTD-Failure (Nack) response, indicating success or failure of the CTD, whereas for a Victim request, the response is a Victim-Release response.

In the illustrative embodiment, the logic circuits of each QBB node are preferably implemented as application specific integrated circuits (ASICs). For example, the local switch 210 comprises a quad switch address (QSA) ASIC and a plurality of quad switch data (QSD0-3) ASICs. The QSA receives command/address information (requests) from the processors, the GP and the IOP, and returns command/address information (control) to the processors and GP via 14-bit, unidirectional links 202. The QSD, on the other hand, transmits and receives data to and from the processors, the IOP and the memory modules via 72-bit, bi-directional links 204.

Each memory module includes a memory interface logic circuit comprising a memory port address (MPA) ASIC and a plurality of memory port data (MPD) ASICs. The ASICs are coupled to a plurality of arrays that preferably comprise synchronous dynamic random access memory (SDRAM) dual in-line memory modules (DIMMs). Specifically, each array comprises a group of four SDRAM DIMMs that are accessed by an independent set of interconnects. That is, there is a set of address and data lines that couple each array with the memory interface logic.

The IOP preferably comprises an I/O address (IOA) ASIC and a plurality of I/O data (IOD0-1) ASICs that collectively provide an I/O port interface from the I/O subsystem to the QBB node. Specifically, the IOP is connected to a plurality of local I/O risers (not shown) via I/O port connections 215, while the IOA is connected to an IOP controller of the QSA and the IODs are coupled to an IOP interface circuit of the QSD. In addition, the GP comprises a GP address (GPA) ASIC and a plurality of GP data (GPD0-1) ASICs. The GP is coupled to the QSD via unidirectional, clock forwarded GP links 206. The GP is further coupled to the HS 400 via a set of unidirectional, clock forwarded address and data HS links 408.

A plurality of shared data structures are provided for capturing and maintaining status information corresponding to the states of data used by the nodes of the system. One of these structures is configured as a duplicate tag store (DTAG) that cooperates with the individual caches of the system to define the coherence protocol states of data cached in the QBB node. The other structure is configured as a directory (DIR) to administer the distributed shared memory environment including the other QBB nodes in the system. The protocol states of the DTAG and DIR are further managed by a coherency engine 220 of the QSA that interacts with these structures to maintain coherency of cache lines in the SMP system.

The DTAG, DIR, coherency engine, IOP, GP and memory modules are interconnected by a logical bus, hereinafter referred to as Arb bus 225. Memory and I/O reference operations issued by the processors are routed by a QSA arbiter 230 over the Arb bus 225. The coherency engine and arbiter are preferably implemented as a plurality of hardware registers and combinational logic configured to produce sequential logic circuits, such as state machines. It should be noted, however, that other configurations of the coherency engine, arbiter and shared data structures may be advantageously used herein.

Operationally, the QSA receives requests from the processors and IOP, and arbitrates among those requests (via the QSA arbiter) to resolve access to resources coupled to the Arb bus 225. If, for example, the request is a memory reference transaction, arbitration is performed for access to the Arb bus based on the availability of a particular memory module, array or bank within an array. In the illustrative embodiment, the arbitration policy enables efficient utilization of the memory modules; accordingly, the highest priority of arbitration selection is preferably based on memory resource availability. However, if the request is an I/O reference transaction, arbitration is performed for access to the Arb bus for purposes of transmitting that request to the IOP. In this case, a different arbitration policy may be utilized for I/O requests and control status register (CSR) references issued to the QSA.

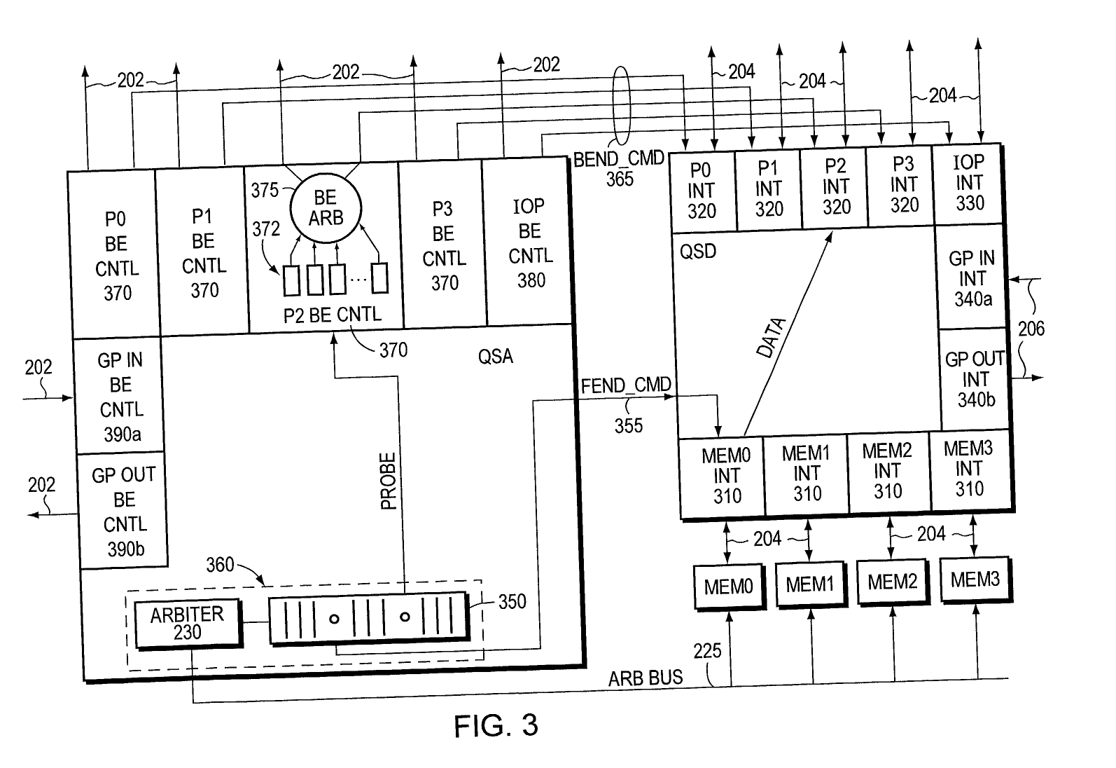

FIG. 3 is a functional block diagram of circuits contained within the QSA and QSD ASICs of the local switch of a QBB node. The QSD includes a plurality of memory (MEM0-3) interface circuits 310, each corresponding to a memory module. The QSD further includes a plurality of processor (P0-P3) interface circuits 320, an IOP interface circuit 330 and a plurality of GP input and output (GPIN and GPOUT) interface circuits 340a,b. These interface circuits are configured to control data transmitted to/from the QSD over the bi-directional clock forwarded links 204 (for P0-P3, MEM0-3 and IOP) and the unidirectional clock forwarded links 206 (for the GP). As described herein, each interface circuit also contains storage elements (i.e., queues) that provide limited buffering capabilities with the circuits.

The QSA, on the other hand, includes a plurality of processor controller circuits 370, along with IOP and GP controller circuits 380, 390. These controller circuits (hereinafter “back-end controllers”) function as data movement engines responsible for optimizing data movement between respective interface circuits of the QSD and the agents corresponding to those interface circuits. The back-end controllers carry-out this responsibility by issuing commands to their respective interface circuits over a back-end command (Bend_Cmd) bus 365 comprising a plurality of lines, each coupling a back-end controller to its respective QSD interface circuit. Each back-end controller preferably comprises a plurality of queues coupled to a back-end arbiter (e.g., a finite state machine) configured to arbitrate among the queues. For example, each processor back-end controller 370 comprises a back-end arbiter 375 that arbitrates among queues 372 for access to a command/address clock forwarded link 202 extending from the QSA to a corresponding processor.

The memory reference transactions issued to the memory modules are preferably ordered at the Arb bus 225 and propagate over that bus offset from each other. Each memory module services the operation issued to it by returning data associated with that transaction. The returned data is similarly offset from other returned data and provided to a corresponding memory interface circuit 310 of the QSD. Because the ordering of transactions on the Arb bus guarantees staggering of data returned to the memory interface circuits from the memory modules, a plurality of independent command/address buses between the QSA and QSD are not needed to control the memory interface circuits. In the illustrative embodiment, only a single front-end command (Fend_Cmd) bus 355 is provided that cooperates with the QSA arbiter 230 and an Arb pipeline 350 to control data movement between the memory modules and corresponding memory interface circuits of the QSD.

The QSA arbiter and Arb pipeline preferably function as an Arb controller 360 that monitors the states of the memory resources and, in the case of the arbiter 230, schedules memory reference transactions over the Arb bus 225 based on the availability of those resources. The Arb pipeline 350 comprises a plurality of register stages that carry command/address information associated with the scheduled transactions over the Arb bus. In particular, the pipeline 350 temporarily stores the command/address information so that it is available for use at various points along the pipeline such as, e.g., when generating a probe directed to a processor in response to a DTAG look-up operation associated with stored command/address.

In the illustrative embodiment, data movement within a QBB node essentially requires two commands. In the case of the memory and QSD, a first command is issued over the Arb bus 225 to initiate movement of data from a memory module to the QSD. A second command is then issued over the front-end command bus 355 instructing the QSD how to proceed with that data. For example, a request (read transaction) issued by P2 to the QSA is transmitted over the Arb bus 225 by the QSA arbiter 230 and is received by an intended memory module, such as MEM0. The memory interface logic activates the appropriate SDRAM DIMM(s) and, at a predetermined later time, the data is returned from the memory to its corresponding MEM0 interface circuit 310 on the QSD. Mean-while, the Arb controller 360 issues a data movement command over the front-end command bus 355 that arrives at the corresponding MEM0 interface circuit at substantially the same time as the data is returned from the memory. The data movement command instructs the memory interface circuit where to move the returned data. That is, the command may instruct the MEM0 interface circuit to move the data through the QSD to the P2 interface circuit 320 in the QSD.

In the case of the QSD and a processor (such as P2), a fill command is generated by the Arb controller 360 and forwarded to the P2 back-end controller 370 corresponding to P2, which issued the read transaction. The controller 370 loads the fill command into a fill queue 372 and, upon being granted access to the command/address link 202, issues a first command over that link to P2 instructing that processor to prepare for arrival of the data. The P2 back-end controller 370 then issues a second command over the back-end command bus 365 to the QSD instructing its respective P2 interface circuit 320 to send that data to the processor.

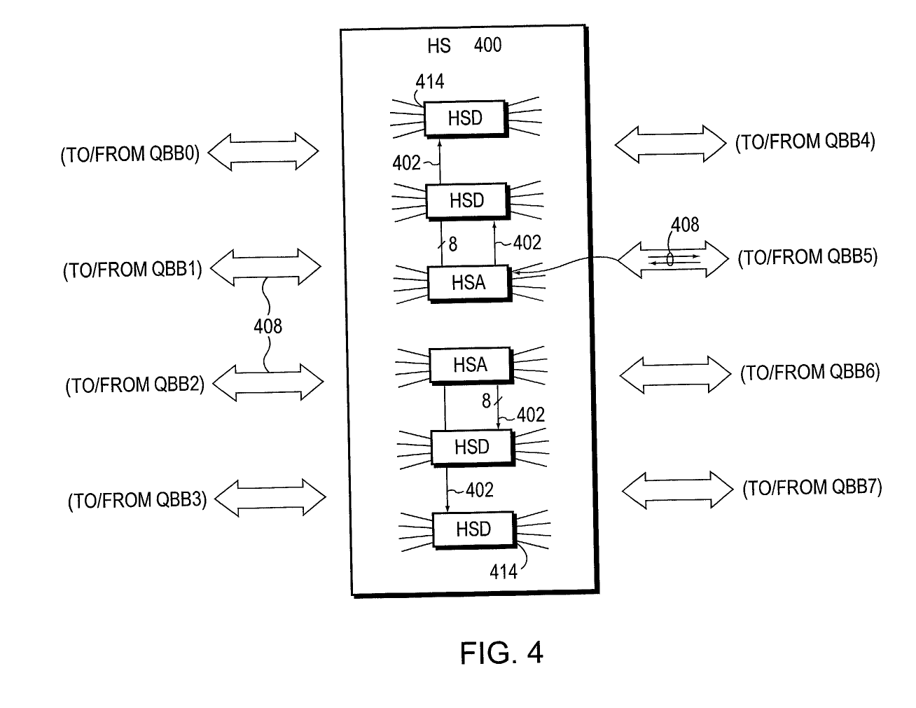

FIG. 4 is a schematic block diagram of the HS 400 comprising a plurality of HS address (HSA) ASICs and HS data (HSD) ASICs. Each HSA preferably controls a plurality of (e.g., two) HSDs in accordance with a master/slave relationship by issuing commands over lines 402 that instruct the HSDs to perform certain functions. Each HSA and HSD further includes eight (8) ports 414, each accommodating a pair of unidirectional interconnects; collectively, these interconnects comprise the HS links 408. In the illustrative embodiment, there are sixteen command/address paths in/out of each HSA, along with sixteen data paths in/out of each HSD. However, there are only sixteen data paths in/out of the entire HS; therefore, each HSD preferably provides a bit-sliced portion of that entire data path and the HSDs operate in unison to transmit/receive data through the switch. To that end, the lines 402 transport eight (8) sets of command pairs, wherein each set comprises a command directed to four (4) output operations from the HS and a command directed to four (4) input operations to the HS.

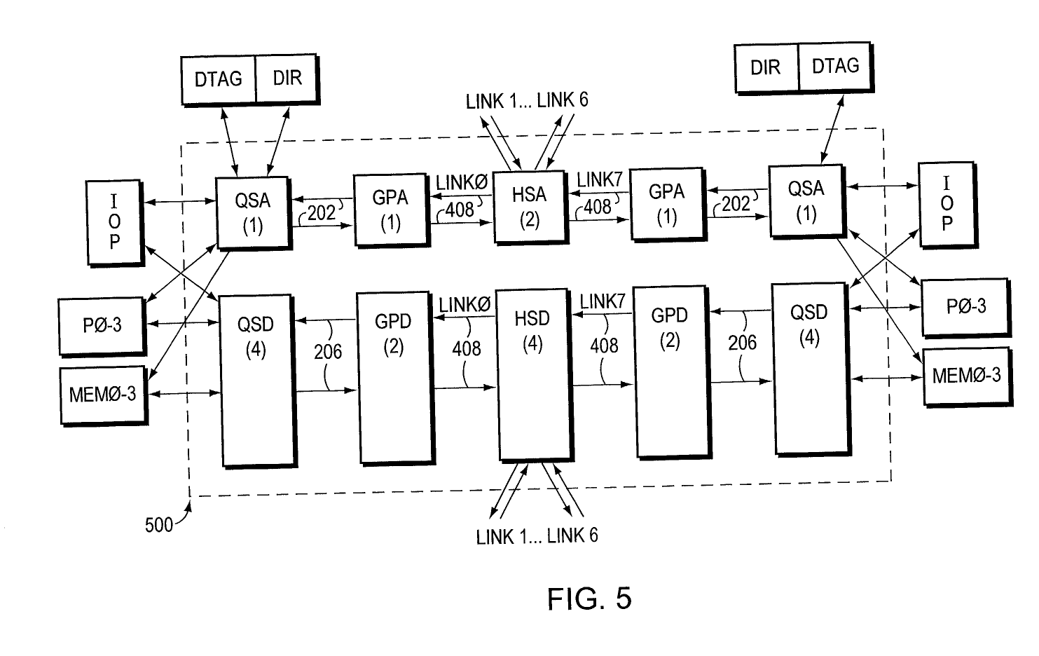

The local switch ASICs in connection with the GP and HS ASICs cooperate to provide a switch fabric of the SMP system. FIG. 5 is a schematic block diagram of the SMP switch fabric 500 comprising the QSA and QSD ASICs of local switches 210, the GPA and GPD ASICs of GPs, and the HSA and HSD ASICs of the HS 400. As noted, operation of the SMP system essentially involves the passing of messages or packets as transactions between agents of the QBB nodes 200 over the switch fabric 500. To support various transactions in system 100, the packets are grouped into various types, including processor command packets, command response packets and probe command packets.

These groups of packets are further mapped into a plurality of virtual channels that enable the transaction packets to traverse the system via similar interconnect resources of the switch fabric. However, the packets are buffered and subject to flow control within the fabric 500 in a manner such that they operate as though they are traversing the system by means of separate, dedicated resources. In the illustrative embodiment described herein, the virtual channels of the SMP system are manifested as queues coupled to a common set of interconnect resources. The present invention is generally directed to managing traffic over these resources (e.g., links and buffers) coupling the QBB nodes 200 to the HS 400. More specifically, the present invention is directed to increasing the performance and bandwidth of the interconnect resources.

### Virtual Channels

Virtual channels are various, independently flow-controlled channels of transaction packets that share common interconnect and/or buffering resources. The transactions are grouped by type and mapped to the various virtual channels to, inter alia, avoid system deadlock. That is, virtual channels are employed in the modular SMP system primarily to avoid deadlock situations over the common sets of resources coupling the ASICs throughout the system. For example rather than having separate links for each type of transaction packet forwarded through the system, the virtual channels are used to segregate that traffic over a common set of physical links. Notably, the virtual channels comprise address/command paths and their associated data paths over the links.

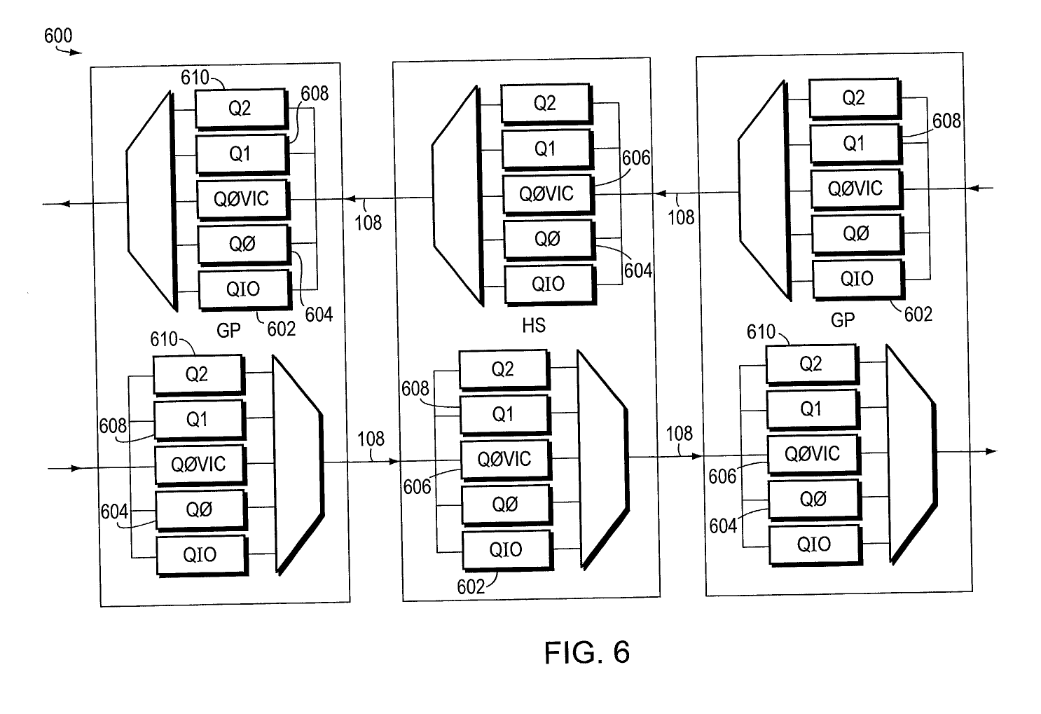

FIG. 6 is a schematic block diagram depicting a queue arrangement 600 wherein the virtual channels are manifested as a plurality of queues located within agents (e.g., the GPs and HS) of the SMP system. It should be noted that the queues generally reside throughout the entire “system” logic; for example, those queues used for the exchange of data are located in the processor interfaces 320, the IOP interfaces 330 and GP interfaces 340 of the QSD. However, the virtual channel queues described herein are located in the QSA, GPA and HSA ASICs, and are used for exchange of command, command response and command probe packets.

In the illustrative embodiment, the SMP system maps the transaction packets into five (5) virtual channel queues. A QIO channel queue 602 accommodates processor command packet requests for programmed input/output (PIO) read and write transactions, including CSR transactions, to I/O address space. A Q0 channel queue 604 carries processor command packet requests for memory space read transactions, while a Q0Vic channel queue 606 carries processor command packet requests for memory space write transactions. A Q1 channel 608 queue accommodates command response and probe packets directed to ordered responses for QIO, Q0 and Q0Vic requests and, lastly, a Q2 channel queue 610 carries command response packets directed to unordered responses for QIO, Q0 and Q0Vic request.

Each of the QIO, Q1 and Q2 virtual channels preferably has its own queue, while the Q0 and Q0Vic virtual channels may, in some cases, share a physical queue. In terms of flow control and deadlock avoidance, the virtual channels are preferably prioritized within the SMP system with the QIO virtual channel having the lowest priority and the Q2 virtual channel having the highest priority. The Q0 and Q0Vic virtual channels have the same priority which is higher than QIO, but lower than Q1 which, in turn, is lower than Q2.

Deadlock is avoided in the SMP system by enforcing two properties with regard to transaction packets and virtual channels: (1) a response to a transaction in a virtual channel travels in a higher priority channel; and (2) lack of progress in one virtual channel cannot impede progress in a second, higher priority virtual channel. The first property eliminates flow control loops wherein transactions in, e.g., the Q0 channel from X to Y are waiting for space in the Q0 channel from Y to X, and wherein transactions in the channel from Y to X are waiting for space in the channel from X to Y. The second property guarantees that higher priority channels continue to make progress in the presence of the lower priority blockage, thereby eventually freeing the lower priority channel.

The virtual channels are preferably divided into two groups: (i) an initiate group comprising the QIO, Q0 and Q0Vic channels, each of which carries request type or initiate command packets; and (ii) a complete group comprising the Q1 and Q2 channels, each of which carries complete type or command response packets associated with the initiate packets. For example, a source processor may issue a request (such as a read or write command packet) for data at a particular address x in the system. As noted, the read command packet is transmitted over the Q0 channel and the write command packet is transmitted over the Q0Vic channel. This arrangement allows commands without data (such as reads) to progress independently of commands with data (such as writes). The Q0 and Q0Vic channels may be referred to as initiate channels. The QIO channel is another initiate channel that transports requests directed to I/O address space (such as requests to CSRs and I/O devices).

A receiver of the initiate command packet may be a memory, DIR or DTAG located on the same QBB node as the source processor. The receiver may generate, in response to the request, a command response or probe packet that is transmitted over the Q1 complete channel. Notably, progress of the complete channel determines the progress of the initiate channel. The response packet may be returned directly to the source processor, whereas the probe packet may be transmitted to other processors having copies of the most current (up-to-date) version of the requested data. If the copies of data stored in the processors' caches are more up-to-date than the copy in memory, one of the processors, referred to as the “owner”, satisfies the request by providing the data to the source processor by way of a Fill response. The data/answer associated with the Fill response is transmitted over the Q2 virtual channel of the system.

Each packet includes a type field identifying the type of packet and, thus, the virtual channel over which the packet travels. For example, command packets travel over Q0 virtual channels, whereas command probe packets (such as FwdRds, Invals and SFills) travel over Q1 virtual channels and command response packets (such as Fills) travel along Q2 virtual channels. Each type of packet is allowed to propagate over only one virtual channel; however, a virtual channel (such as Q0) may accommodate various types of packets. Moreover, it is acceptable for a higher-level channel (e.g., Q2) to stop a lower-level channel (e.g., Q1) from issuing requests/probes when implementing flow control; however, it is unacceptable for a lower-level channel to stop a higher-level channel since that would create a deadlock situation.

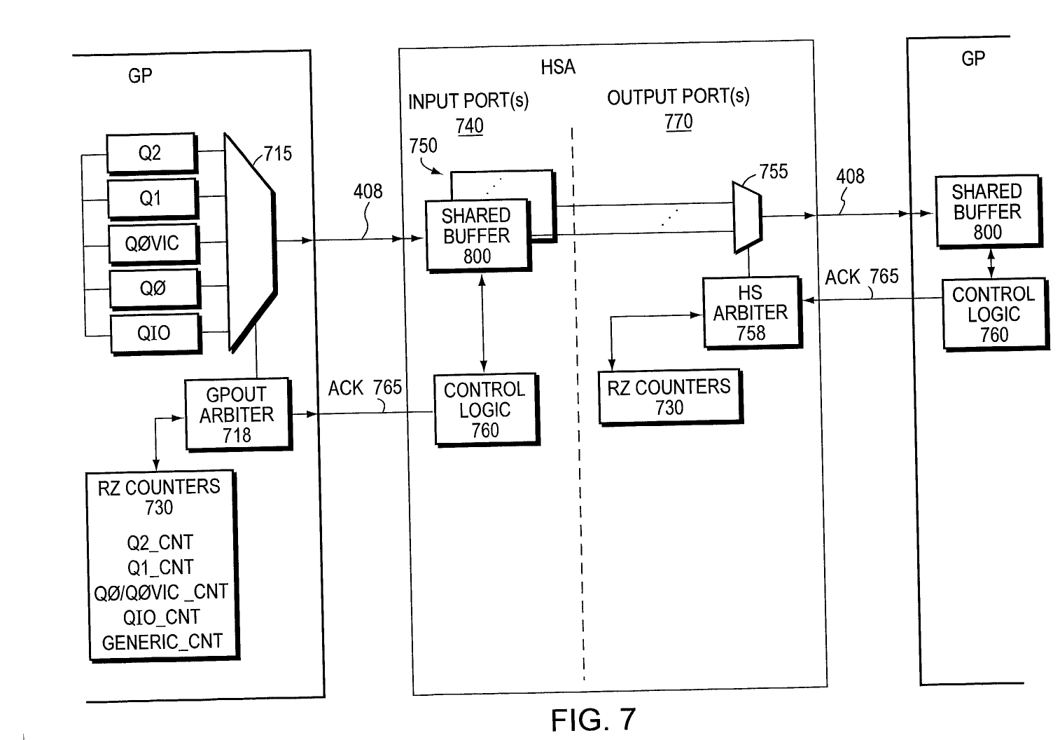

FIG. 7 is a schematized block diagram of logic circuitry located within the GPA and HSA ASICs of the switch fabric in the SMP system. The GPA comprises a plurality of queues organized similar to the queue arrangement 600. Each queue is associated with a virtual channel and is coupled to an input of a GPOUT selector circuit 715 having an output coupled to HS link 408. A finite state machine functioning as, e.g., a GPOUT arbiter 718 arbitrates among the virtual channel queues and enables the selector to select a command packet from one of its queue inputs in accordance with a forwarding decision. The GPOUT arbiter 718 preferably renders the forwarding decision based on predefined ordering rules of the SMP system, together with the availability and scheduling of commands for transmission from the virtual channel queues over the HS link.

The selected command is driven over the HS link 408 to an input buffer arrangement 750 of the HSA. The HS is a significant resource of the SMP system that is used to forward packets between the QBB nodes of the system. The HS is also a shared resource that has finite logic circuits (“gates”) available to perform the packet forwarding function for the SMP system. Thus, instead of having separate queues for each virtual channel, the HS utilizes a shared buffer arrangement 750 that conserves resources within the HS and, in particular, reduces the gate count of the HSA and HSD ASICs. Notably, there is a data entry of a shared buffer in the HSD that is associated with each command entry of the shared buffer in the HSA. Accordingly, each command entry in the shared buffer 800 can accommodate a full packet regardless of its type, while the corresponding data entry in the HSD can accommodate a 64-byte block of data associated with the packet.

The shared buffer arrangement 750 comprises a plurality of HS buffers 800, each of which is shared among the five virtual channel queues of each GPOUT controller 390b. The shared buffer arrangement 750 thus preferably comprises eight (8) shared buffers 800 with each buffer associated with a GPOUT controller of a QBB node 200. Buffer sharing within the HS is allowable because the virtual channels generally do not consume their maximum capacities of the buffers at the same time. As a result, the shared buffer arrangement is adaptable to the system load and provides additional buffering capacity to a virtual channel requiring that capacity at any given time. In addition, the shared HS buffer 800 may be managed in accordance with the virtual channel deadlock avoidance rules of the SMP system.

The packets stored in the entries of each shared buffer 800 are passed to an output port 770 of the HSA. The HSA has an output port 770 for each QBB node (i.e., GPIN controller) in the SMP system. Each output port 770 comprises an HS selector circuit 755 having a plurality of inputs, each of which is coupled to a buffer 800 of the shared buffer arrangement 750. An HS arbiter 758 enables the selector 755 to select a command packet from one of its buffer inputs for transmission to the QBB node. An output of the HS selector 755 is coupled to HS link 408 which, in turn, is coupled to a shared buffer of a GPA. As described herein, the shared GPIN buffer is substantially similar to the shared HS buffer 800.

The association of a packet type with a virtual channel is encoded within each command contained in the shared HS and GPIN buffers. The command encoding is used to determine the virtual channel associated with the packet for purposes of rendering a forwarding decision for the packet. As with the GPOUT arbiter 718, the HS arbiter 758 renders the forwarding decision based on predefined ordering rules of the SMP system, together with the availability and scheduling of commands for transmission from the virtual channel queues over the HS link 408.

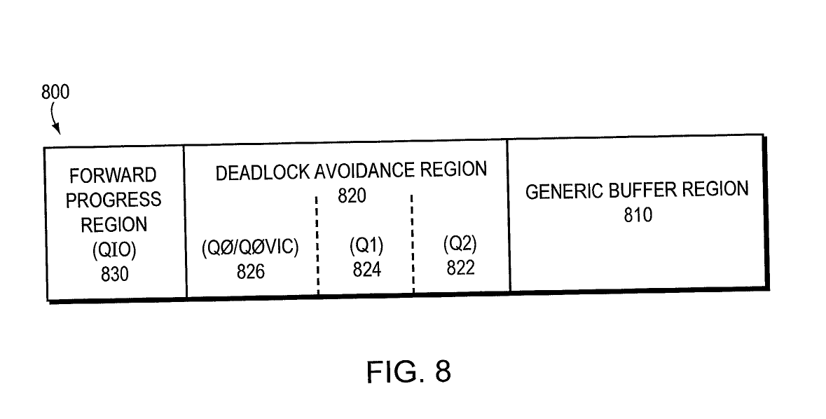

FIG. 8 is a schematic block diagram of the shared buffer 800 comprising a plurality of entries associated with various regions of the buffer. The buffer regions preferably include a generic buffer region 810, a deadlock avoidance region 820 and a forward progress region 830. The generic buffer region 810 is used to accommodate packets from any virtual channel, whereas the deadlock avoidance region 820 includes three entries 822-826, one each for Q2, Q1 and Q0/Q0Vic virtual channels. The three entries of the dead-lock avoidance region allow the Q2, Q1 and Q0/Q0Vic virtual channel packets to progress through the HS 400 regardless of the number of QIO, Q0/Q0Vic and Q1 packets that are temporarily stored in the generic buffer region 810. The forward progress region 830 guarantees timely resolution of all QIO transactions, including CSR write transactions used for posting interrupts in the SMP system, by allowing QIO packets to progress through the SMP system.

It should be noted that the deadlock avoidance and forward progress regions of the shared buffer 800 may be implemented in a manner in which they have fixed correspondence with specific entries of the buffer. They may, however, also be implemented as in a preferred embodiment where a simple credit-based flow control technique allows their locations to move about the set of buffer entries.

Because the traffic passing through the HS may vary among the virtual channel packets, each shared HS buffer 800 requires elasticity to accommodate and ensure forward progress of such varying traffic, while also obviating deadlock in the system. The generic buffer region 810 addresses the elasticity requirement, while the deadlock avoidance and forward progress regions 820, 830 address the deadlock avoidance and forward progress requirements, respectively. In the illustrative embodiment, the shared buffer comprises eight (8) transaction entries with the forward progress region 830 occupying one QIO entry, the deadlock avoidance region 820 consuming three entries and the generic buffer region 810 occupying four entries.

Global transfers in the SMP system, i.e., the transfer of packets between QBB nodes, are governed by flow control and arbitration rules at the GP and HS. The arbitration rules specify priorities for channel traffic and ensure fairness. Flow control, on the other hand, is divided into two independent mechanisms, one to prevent buffer overflow and deadlock (i.e., the RedZone_State) and the other to enhance performance (i.e., the Init_State). The state of flow control effects the channel arbitration rules.

### RedZone Flow Control

The logic circuitry and shared buffer arrangement shown in FIG. 7 cooperate to provide a “credit-based” flow control mechanism that utilizes a plurality of counters to essentially create the structure of the shared buffer 800. That is, the shared buffer does not have actual dedicated entries for each of its various regions. Rather, counters are used to keep track of the number of packets per virtual channel that are transferred, e.g., over the HS link 408 to the shared HS buffer 800. The GPA preferably keeps track of the contents of the shared HS buffer 800 by observing the virtual channels over which packets are being transmitted to the HS.

Broadly stated, each sender (GP or HS) implements a plurality of RedZone (RZ) flow control counters, one for each of the Q2, Q1 and QIO channels, one that is shared between the Q0 and Q0Vic channels, and one generic buffer counter. Each receiver (HS or GP, respectively) implements a plurality of acknowledgement (Ack) signals, one for each of the Q2, Q1, Q0, Q0Vic and QIO channels. These resources, along with the shared buffer, are used to implement a RedZone flow control technique that guarantees deadlock-free operation for both a GP-to-HS communication path and an HS-to-GP path.

### The GPOUT-to-HS Path

As noted, the shared buffer arrangement 750 comprises eight, 8-entry shared buffers 800, and each buffer may be considered as being associated with a GPOUT controller 390b of a QBB node 200. In an alternate embodiment of the invention, four 16-entry buffers may be utilized, wherein each buffer is shared between two GP OUT controllers. In this case, each GPOUT controller is provided access to only 8 of the 16 entries. When only one GPOUT controller is connected to the HS buffer, however, the controller 390b may access all 16 entries of the buffer. Each GPA coupled to an input port 740 of the HS is configured with a parameter (HS_Buf_Level) that is assigned a value of eight or sixteen indicating the HS buffer entries it may access. The value of sixteen may be used only in the alternate, 16-entry buffer embodiment where global ports are connected to at most one of every adjacent pair of HS ports. The following portion of a RedZone algorithm (i.e., the GP-to-HS path) is instantiated for each GP connected to the HS, and is implemented by the GPOUT arbiter 718 and HS control logic 760.

In an illustrative embodiment, the GPA includes a plurality of RZ counters 730: (i) HS_Q2_Cnt, (ii) HS_Q1_Cnt, (iii) HS_Q0/Vic_Cnt, (iv) HS_QIO_Cnt, and (v) HS_Generic_Cnt counters. Each time the GPOUT controller issues a Q2, Q1, Q0/Q0Vic or QIO packet to the HS 400, it increments, respectively, one of the HS_Q2_Cnt, HS_Q1_Cnt, HS_Q0/Q0Vic_Cnt or HS_QIO_Cnt counters. Each time the GPA issues a Q2, Q1, or Q0/Q0Vic packet to the HS and the previous value of the respective counter HS_Q2_Cnt, HS_Q1_Cnt or HS_Q0/Q0Vic_Cnt is equal to zero, the packet is assigned to the associated entry 822-826 of the deadlock avoidance region 820 in the shared buffer 800. Each time the GPA issues a QIO packet to the HS and the previous value of the HS_QIO_Cnt counter is equal to zero, the packet is assigned to the entry of the forward progress region 830.

On the other hand, each time the GPA issues a Q2, Q1, Q0/Q0Vic or QIO packet to the HS and the previous value of the respective HS_Q2_Cnt, HS_Q1_Cnt, HS_Q0/Q0Vic_Cnt or HS_QIO_Cnt counter is non-zero, the packet is assigned to an entry of the generic buffer region 810. As such, the GPOUT arbiter 718 increments the HS_Generic_Cnt counter in addition to the associated HS_Q2_Cnt, HS_Q1_Cnt, HS_Q0/Q0Vic_Cnt or HS_QIO_Cnt counter. When the HS_Generic_Cnt counter reaches a predetermined value, all entries of the generic buffer region 810 in the shared buffer 800 for that GPA are full and the input port 740 of the HS is defined to be in the RedZone_State. When in this state, the GPA may issue requests to only unused entries of the deadlock avoidance and forward progress regions 820, 830. That is, the GPA may issue a Q2, Q1, Q0/Q0Vic or QIO packet to the HS only if the present value of the respective HS_Q2_Cnt, HS_Q1_Cnt, HS_Q0/Q0Vic_Cnt or HS_QIO_Cnt counter is equal to zero.

Each time a packet is issued to an output port 770 of the HS, the control logic 760 of the HS input port 740 deallocates an entry of the shared buffer 800 and sends an Ack signal 765 to the GPA that issued the packet. The Ack is preferably sent to the GPA as one of a plurality of signals, e.g., HS_Q2_Ack, HS_Q1_Ack, HS_Q0_Ack, HS_Q0vic_Ack and HS_QIO_Ack, depending upon the type of issued packet. Upon receipt of an Ack signal, the GPOUT arbiter 718 decrements at least one RZ counter 730. For example, each time the arbiter 718 receives a HS_Q2_Ack, HS_Q1_Ack, HS_Q0_Ack, HS_Q0Vic_Ack or HS_QIO_Ack signal, it decrements the respective HS_Q2_Cnt, HS_Q1_Cnt, HS_Q0/Q0Vic_Cnt or HS_QIO_Cnt counter. Moreover, each time the arbiter receives a HS_Q2_Ack, HS_Q1_Ack, HS_Q0_Ack, HS_Q0Vic_Ack or HS_QIO_Ack signal and the previous value of the respective HS_Q2_Cnt, HS_Q1_Cnt, HS_Q0/Q0Vic_Cnt or HS_QIO_Cnt counter has a value greater than one (i.e., the successive value of the counter is non-zero), the GPOUT arbiter 718 also decrements the HS_Generic_Cnt counter.

### The HS-to-GPIN Path

The credit-based, flow control technique for the HS-to-GPIN path is substantially identical to that of the GPOUT-to-HS path in that the shared GPIN buffer 800 is managed in the same way as the shared HS buffer 800. That is, there is a set of RZ counters 730 within the output port 770 of the HS that create the structure of the shared GPIN buffer 800. When a command is sent from the output port 770 over the HS link 408 and onto the shared GPIN buffer 800, a counter 730 is incremented to indicate the respective virtual channel packet sent over the HS link. When the virtual channel packet is removed from the shared GPIN buffer, Ack signals 765 are sent from GPIN control logic 760 of the GPA to the output port 770 instructing the HS arbiter 758 to decrement the respective RZ counter 730. Decrementing of a counter 730 indicates that the shared buffer 800 can accommodate another respective type of virtual channel packet.

In the illustrative embodiment, however, the shared GPIN buffer 800 has sixteen (16) entries, rather than the eight (8) entries of the shared HS buffer. The parameter indicating which GP buffer entries to access is the GPin_Buf_Level. The additional entries are provided within the generic buffer region 810 to increase the elasticity of the buffer 800, thereby accommodating additional virtual channel commands. The portion of the RedZone algorithm described below (i.e., the HS-to-GPIN path) is instantiated eight times, one for each output port 770 within the HS 400, and is implemented by the HS arbiter 758 and GPIN control logic 760.

In the illustrative embodiment, each output port 770 includes a plurality of RZ counters 730: (i) GP_Q2 Cnt, (ii) GP_Q1_Cnt, (iii) GP_Q0/Q0Vic_Cnt, (iv) GP_QIO_Cnt and (v) GP_Generic_Cnt counters. Each time the HS issues a Q2, Q1, Q0/Q0Vic, or QIO packet to the GPA, it increments, respectively, one of the GP_Q2_Cnt, GP_Q1_Cnt, GP_Q0/Q0Vic_Cnt or GP_QIO_Cnt counters. Each time the HS issues a Q2, Q1, or Q0/Q0Vic to the GPIN and the previous value of the respective GP_Q2_Cnt, GP_Q1_Cnt, or Q0/Q0Vic_Cnt counter is equal to zero, the packet is as-signed to the associated entry of the deadlock avoidance region 820 in the shared buffer 800. Each time the HS issues a QIO packet to the GPIN controller 390a and the previous value of the GP_QIO_Cnt counter is equal to zero, the packet is assigned to the entry of the forward progress region 830.

On the other hand, each time the HS issues a Q2, Q1, Q0/Q0Vic or QIO packet to the GPA and the previous value of the respective GP_Q2_Cnt, GP_Q1_Cnt, GP_Q0/Q0Vic_Cnt or GP_QIO_Cnt is non-zero, the packet is assigned to an entry of the generic buffer region 810 of the GPIN buffer 880. As such, the HS arbiter 758 increments the GP_Generic_Cnt counter, in addition to the associated GP_Q2_Cnt, GP_Q1_Cnt, GP_Q0Vic_Cnt or GP_QIO_Cnt counter. When the GP_Generic_Cnt counter reaches a predetermined value, all entries of the generic buffer region 810 in the shared GPIN buffer 800 are full and the output port 770 of the HS is defined to be in the RedZone_State. When in this state, the output port 770 may issue requests to only unused entries of the deadlock avoidance and forward progress regions 820, 830. That is, the output port 770 may issue a Q2, Q1, Q0/Q0Vic or QIO packet to the GPIN controller 390a only if the present value of the respective GP_Q2_Cnt, GP_Q1_Cnt, GP_Q0/Q0Vic_Cnt or GP_QIO_Cnt counter is equal to zero.

Each time a packet is retrieved from the shared GPIN buffer 800, control logic 760 of the GPA deallocates an entry of that buffer and sends an Ack signal 765 to the output port 770 of the HS 400. The Ack signal 765 is sent to the output port 770 as one of a plurality of signals, e.g., GP_Q2_Ack, GP_Q1_Ack, GP_Q0_Ack, GP_Q0Vic_Ack and GP_QIO_Ack, depending upon the type of issued packet. Upon receipt of an Ack signal, the HS arbiter 758 decrements at least one RZ counter 730. For example, each time the HS arbiter receives a GP_Q2_Ack, GP_Q1_Ack, GP_Q0_Ack, GP_Q0Vic_Ack or GP_QIO_Ack signal, it decrements the respective GP_Q2_Cnt, GP_Q1_Cnt, GP_Q0/Q0Vic_Cnt or GP_Generic_Cnt counter. Moreover, each time the arbiter receives a GP_Q2_Ack, GP_Q1_Ack, GP_Q0_Ack, GP_Q0Vic_Ack or GP_QIO_Ack signal and the previous value of the respective GP_Q2_Cnt, GP_Q1_Cnt, GP_Q0/Q0Vic_Cnt or GP_Generic_Cnt counter has a value greater than one (i.e., the successive value of the counter is non-zero), the HS arbiter 758 decrements the GP_Generic_Cnt counter.

The GPOUT and HS arbiters implement the RedZone algorithms described above by, inter alia, examining the RZ counters and transactions pending in the virtual channel queues, and determining whether those transactions can make progress through the shared buffers 800. If an arbiter determines that a pending transaction/reference can progress, it arbitrates for that reference to be loaded into the buffer. If, on the other hand, the arbiter determines that the pending reference cannot make progress through the buffer, it does not arbitrate for that reference.

Specifically, anytime a virtual channel entry of the deadlock avoidance region 820 is free (as indicated by the counter associated with that virtual channel equaling zero), the arbiter can arbitrate for the channel because the shared buffer 800 is guaranteed to have an available entry for that packet. If the deadlock avoidance entry is not free (as indicated by the counter associated with that virtual channel being greater than zero) and the generic buffer region 810 is full, then the packet is not forwarded to the HS because there is no entry available in the shared buffer for accommodating the packet. Yet, if the dead-lock avoidance entry is occupied but the generic buffer region is not full, the arbiter can arbitrate to load the virtual channel packet into the buffer.

While there has been shown and described illustrative embodiments for utilizing a plurality of counters to determine whether transactions pending in virtual channel queues of a switch fabric within modular multiprocessor system can make progress through interconnect resources of the fabric, it is to be understood that various other adaptations and modifications may be made within the spirit and scope of the invention. For example, the RedZone algorithms described herein represent a first level of arbitration for rendering a forwarding decision for a virtual channel packet that considers the flow control signals to determine whether there is sufficient room in the shared buffer for the packet. If there is sufficient space for the packet, a next determination is whether there is sufficient bandwidth on other interconnect resources (such as the HS links) coupling the GP and HS. If there is sufficient bandwidth on the links, then the arbiter implements an arbitration algorithm to determine which of the remaining virtual channel packets may access the HS links. An example of the arbitration algorithm implemented by the arbiter is a “not most recently used” algorithm.

### Shared-Source Buffer (SSB)

The logic circuitry and shared buffer arrangement shown in FIG. 7 implement a structure that shares resources for each type of virtual channel packet, but for which the resources are dedicated to a single source. An alternative arrangement is to additionally share the buffer resources across all sources. This arrangement benefits system performance when some sources are more active than others, providing elasticity to accommodate such varying traffic. The tradeoff for this elasticity is that each source can no longer determine the precise count of available generic slots in the buffer. Instead of a source-based counter credit technique for determining generic slot availability, a modified flow control technique may be used to broadcast the RedZone state to each source.

In the SMP system, the shared-resource buffer arrangement comprises one, 64-entry shared buffer, wherein each buffer is shared by all eight GPOUT controllers from the eight QBB nodes. Of these 64 entries, one slot per source is dedicated to a Q2, Q1 or Q0/Q0Vic packet for a total of 24 dedicated slots. The remaining 40 slots are shared for all channel types and sources. Note that the eight QIO forward progress slots can be considered included among the 40 generic slots.

The flow control mechanism for utilizing these shared-source buffers is similar to the dedicated-source buffers with some notable differences. A plurality of per-channel flow control counters, one for each of the Q2, Q1, and QIO channels, and one that is shared between the Q0 and Q0Vic channels, is implemented at each GPOUT source controller. However, instead of a generic buffer counter implemented at each source, two counters are implemented in the HSA input port controller, one for counting the number of generic slots in use in the buffer and one for predicting the number of transactions which may be in transit from the eight sources. These two counters in the HSA input port controller are used to calculate the RedZone state.

Like any other flow control scheme that requires broadcast of a state condition from the destination resource back to the source, a measure of uncertainty attributable to the latency of this broadcast must be accounted for when calculating the state. In this example, the critical resource is the number of available generic slots in the shared-source buffer. In an ideal zero-latency model, the RedZone state is asserted simply when the count of these available generic slots is zero. However, in a physical implementation, there is a latency cost when broadcasting this state to the source of the transactions. During the time it takes for the RedZone state assertion to reach the source and stop transactions, additional packets sent during this latency may cause the buffer to overflow. The transactions sent during this latency are considered “in transit” or “in flight” and must be accounted for when calculating the RedZone state. Thus, instead of asserting RedZone state when the number of available generic slots is zero, the state is instead asserted when the number of available generic slots is less than or equal to the number of packets in transit.

### Transit-Count

At least two parameters are needed to calculate the number of transactions in transit: a “loop latency” of the flow control and the bandwidth of the input port. The loop latency is best illustrated by the total time required for the following events:

1. Control logic at the destination resource determines that a new slot is available.

2. Flow control information for this new slot is transmitted to the source.

3. The source has transactions that are awaiting the flow control information, and sends a new packet as soon as this flow control information is received.

4. The destination resource receives the new packet and updates the state information it uses for flow control.

The bandwidth of the input port is a measure of the number of packets that can be transmitted as a function of time. The peak bandwidth of the input port is calculated assuming no contributions from flow control. If packets are sent with variable sizes, the peak bandwidth additionally assumes all packets are of the smallest size, and can thus be sent “closer” together. A packet cycle is defined as the unit of time corresponding to the peak bandwidth of the smallest packets. It is convenient to express loop latency in units of packet cycles.

In the SMP system, the packet cycle is preferably equal to two frame clocks (19.2 ns). The cumulative peak bandwidth across all eight QBB nodes is thus 8 packets every two frame clocks. The loop latency is 8 frame clocks (172.8 ns) or, equivalently, 4 packet cycles. The maximum number of packets in transit from all eight QBB nodes is thus 32 packets.

If the maximum is always used for the transit count, the buffer will likely never be fully utilized, and typically will be unsatisfactorily underutilized. Instead of using peak bandwidth as a constant parameter for calculating the transit count, the transit count can be a dynamic function of the maximum realized bandwidth as calculated using a history of the flow control state. This method is necessary and required in order for a shared source buffer to be considered viable.

The transit-count is a function of a history of the RedZone state. The history needs to record the last number of packet cycles equal to the loop latency. If the RedZone state has been deasserted for the entire recorded history, the transit-count is equal to the maximum number of packets in transit. For every packet cycle in which RedZone state is asserted in the history, the transit-count is less than the maximum by the 1 packet cycle bandwidth. For example, assume a loop latency equal to 4 packet cycles and a packet cycle bandwidth of 8. If RedZone has been 0 for the previous 4 packet cycles, the transit-count is equal to 32; if RedZone has been 0 for three of the previous 4 cycles, the transit-count is equal to 24; and so on. The transit-count is equal to 0 if RedZone has been asserted for all 4 previous cycles.

### RedZone State

RedZone state is asserted whenever there are less generic slots available than the sum of the transit-count plus 1 packet cycle bandwidth. In the embodiment described herein, this sum is equal to (transit-count+8). The natural hysteresis provided by this sum compensates for the effect of deasserting the RedZone state. Note that this sum ensures that the number of available generic slots at any time is always at least as large as the value of the transit-count.

A brief examination using the illustrative SMP system described herein shows how this variable transit-count works to eventually gain full utilization of the shared-source buffer.

1. When idle, the transit-count starts at a pessimistic maximum number of packets in flight. In a configuration with 64 total slots (40 of these being generic), the maximum value of the transit-count is 32.

2. As traffic begins to fill the generic slots, the RedZone state is asserted as soon as 8 generic slots are occupied (32 available). On the next cycle, the transit-count is reduced to 24.

3. Unless 8 new packets arrive in the next packet cycle, the RedZone state can be deasserted. The transit-count remains at 24. This “throttle” of one RedZone state assertion per 4 packet cycles continues as long as the generic buffer is between 8 and 15 slots utilized (25-32 available).

4. Once 16 generic slots are utilized, RedZone state is asserted and the transit-count drops to 16. The throttle is now two assertions of RedZone state per 4 packet cycles. Note that as long as there are some cycles of deasserted RedZone state, generic slots can still be filled.

5. Eventually, 24 and then 32 generic slots may be utilized. Once the generic slots exceed 32, the transit-count drops to 0 and RedZone state remains asserted. If there had been enough packets in transit during the last RedZone deassertion, the generic slots can achieve full utilization.

At the source, the GPOUT control logic uses the per-channel counters along with the received RedZone state to determine buffer availability. This algorithm is identical to the dedicated-source buffer method. A channel “pends” for arbitration if its respective per-channel counter is 0 or if the RedZone state is deasserted. The per-channel counter is incremented when a packet is transmitted and decremented when its respective acknowledge credit is received.

There are alternatives to the implementation of a shared-source buffer. One alternative reduces the complexity of the physical implementation, with the trade-off of fewer buffers shared for each source. Another alternative increases the probability that the buffer can be fully utilized with the trade-off of added implementation complexity. These alternatives are minor distinctions and differ only in implementation from the concept described by the general method.

### Split Shared-Source Buffer

In order to reduce physical connectivity, it is not necessary that all sources share the same buffer. This alternative splits the buffer resources into slices, with each slice shared by a subset of sources. For example, the 8 QBB nodes of the SMP system may use two buffer slices, each sharing 4 source nodes. Each respective buffer slice still connects its output ports to all 8 QBB nodes. In addition to reduced connectivity, the generic-count and transit-count counters can be smaller and arithmetic may use fewer bits. Note that the logic for the counters is replicated independently for each of the two slices, however.

### Different RedZone State to Subset of Sources

One limitation preventing the source-shared buffer from achieving full utilization is the requirement to leave the full packet cycle bandwidth allotted even when RedZone state is always asserted. This is represented by the additional 8 generic slots added to the transit-count before comparing with the number of available generic slots. In the case when the transit-count is 0 and the number of available generic slots is 7, RedZone will not deassert to allow the buffer to achieve full utilization. An alternative is to use additional conditions in order to deassert RedZone state to a subset of sources. For example, if only (transit-count+4) generic slots are available, the RedZone state can deassert for 4 of the source nodes and assert for the other 4.

The foregoing description has been directed to specific embodiments of the present invention. It will be apparent, however, that other variations and modifications may be made to the described embodiments, with the attainment of some or all of their advantages. Therefore, it is the object of the appended claims to cover all such variations and modifications as come within the true spirit and scope of the invention.

What is claimed is:

1. A method for creating a load balancing, deadlock-free virtual channel communication structure in a shared buffer resource of a switch fabric within a modular multiprocessor system, the switch fabric interconnecting a plurality of nodes and configured to transport transaction packets having a plurality of types from a global input port of a first node through a hierarchical switch to a global output port of a second node, the method comprising the steps of:
establishing within the switch fabric a plurality of virtual channel queues, each queue storing a type of transaction packet;
providing a plurality of counters, each counter associated with a virtual channel queue;and
structuring the shared buffer resource through use of the counters so as to create:
a generic buffer region having entries for accommodating any type of transaction packet,
a forward progress region having one or more entries for accommodating a first type of transaction packet, and
a deadlock avoidance region having entries for accommodating one or more second types of transaction packets.

2. The method of claim 1 further comprising the steps of:
issuing a transaction packet from a virtual channel queue to the shared buffer resource;
in response to the step of issuing, incrementing the counter associated with the virtual channel queue, and one of:
if the packet is of the first type of transaction packet and a previous value of the associated counter is zero, assigning the packet to a respective entry of the forward progress region; and
if the packet is one of the second types of transaction packets and a previous value of the associated counter is equal to zero, assigning the packet to a respective entry of the deadlock avoidance region.

3. The method of claim 2 further comprising the steps of:
if the packet is of the first or one of the second types of transaction packets and a previous value of the associated counter is non-zero, assigning the packet to a respective entry of the generic buffer region; and
incrementing a generic counter in addition to the counter associated with the virtual channel packet.

4. The method of claim 3 further comprising the step of, when the generic counter reaches a predetermined value, issuing only those types of transaction packets that can be accommodated within unused entries of the deadlock avoidance and forward progress regions of the shared buffer resource.

5. The method of claim 4 further comprising the steps of:
removing a transaction packet from the shared buffer resource;
issuing an acknowledgement that specifies the type of transaction packet that was removed;
in response to the acknowledgement, decrementing the counter for the virtual channel queue associated with the transaction packet type that was removed from the shared buffer resource; and
if a successive value of the decremented counter is non-zero, decrementing the generic counter.

6. The method of claim 5 wherein
the first type of transaction packets correspond to programmed input/output (I/O) read and write requests, and
the second types of transaction packets correspond to:
read and write requests directed to memory,
ordered responses and probes associated with programmed I/O and memory read/write requests, and
unordered responses to programmed I/O and memory read/write requests.

7. The method of claim 6 wherein the virtual channel queues include:
a programmed input/output (I/O) read/write virtual channel queue;
a memory read virtual channel queue;
a memory write virtual channel queue;
an ordered response and probe virtual channel queue for responses and probes associated with programmed I/O and memory read/write requests, and
an unordered response virtual channel queue for responses associated with programmed I/O and memory read/write requests.

8. The method of claim 7 wherein the memory read and memory write virtual channel queues share a single counter.

9. The method of claim 1 wherein the shared buffer resource is dedicated to a single node of the multiprocessor system.

10. The method of claim 1 wherein the shared buffer resource is shared among a plurality of nodes of the multiprocessor system.

11. A switch fabric for interconnecting a plurality of nodes of a modular multiprocessor system, the nodes configured to source and receive transaction packets having a plurality of types, the switch fabric comprising:
a plurality of virtual channel queues, each queue configured and arranged to store a type of transaction packet;
a plurality of counters, each counter associated with a virtual channel queue;
an arbiter for incrementing and decrementing the counters; and
a shared buffer resource coupled to the virtual channel queues and configured to transport transaction packets among the nodes of the multiprocessor system,
wherein the arbiter utilizes the counters to organize the shared buffer resource into a plurality of regions including:
a generic buffer region having entries for accommodating any type of transaction packet,
a forward progress region having one or more entries for accommodating a first type of transaction packet, and
a deadlock avoidance region having entries for accommodating one or more second types of transaction packets.

12. The switch fabric of claim 11 wherein the arbiter, in response to a transaction packet being issued from a virtual channel queue to the shared buffer resource, increments the counter associated with the respective virtual channel queue, and one of:
if the packet is of the first type of transaction packet and a previous value of the associated counter is zero, the arbiter considers the packet as being assigned to a respective entry of the forward progress region of the shared buffer resource, and
if the packet is one of the second types of transaction packets and a previous value of the associated counter is equal to zero, the arbiter considers the packet as being assigned to a respective entry of the deadlock avoidance region.

13. The switch fabric of claim 12 wherein, if the packet is of the first or one of the second types of transaction packets and a previous value of the associated counter is non-zero, the arbiter considers the packet as being assigned to a respective entry of the generic buffer region, and increments a generic counter in addition to the counter associated with the virtual channel packet.

14. The switch fabric of claim 13 wherein the arbiter is configured such that, when the generic counter reaches a predetermined value, the arbiter issues only those types of transaction packets that can be accommodated within unused entries of the deadlock avoidance and forward progress regions of the shared buffer resource.

15. The switch fabric of claim 14 further comprising control logic operably coupled to the shared buffer resource, wherein
in response to a transaction packet being removed from the shared buffer resource, the control logic issues an acknowledgement to the arbiter that specifies the type of transaction packet that was removed,
in response to the acknowledgement, the arbiter decrements the counter for the virtual channel queue associated with the transaction packet type that was removed from the shared buffer resource, and
if a successive value of the decremented counter is non-zero, the arbiter decrements the generic counter.
